(19) United States
(12) Patent Application Publication
(10) Pub. No.: US 2013/0057592 A1
(43) Pub. Date: Mar. 7, 2013

(54) COLOR ADJUSTING SYSTEM FOR USE IN VIDEO WALL

(71) Applicant: Ching-Teng TSENG, Taoyuan Hsien (TW)

(72) Inventor: Ching-Teng TSENG, Taoyuan Hsien (TW)

(73) Assignee: DELTA ELECTRONICS, INC., Taoyuan Hsien (TW)

(21) Appl. No.: 13/333,103

(22) Filed: Dec. 21, 2011

(30) Foreign Application Priority Data
Sep. 6, 2011 (CN) 201110285286.9

(51) Int. Cl. G09G 5/10

(52) U.S. Cl. 345/690

(57) ABSTRACT

A color adjusting system for use in a video wall is provided. The color adjusting system comprises a plurality of color sensors and a processing module. The color sensors are configured to sense a plurality of red light signals, a plurality of green light signals, a plurality of blue light signals and a plurality of white light signals generated from a plurality of light modules of a plurality of display devices of the video wall. The processing module is configured to calculate a red light color space coordinate criterion value of the red light signals, a green light color space coordinate criterion value of the green light signals, a blue light color space coordinate criterion value of the blue light signals and a white light color space coordinate criterion value of the white light signals respectively so that the display devices can adjust the light modules accordingly.

This application claims priority to China Patent Application No. 201110285286.9 filed on Sep. 6, 2011, which is hereby incorporated by reference in its entirety

### CROSS-REFERENCES TO RELATED APPLICATIONS

Not applicable.

### BACKGROUND OF THE INVENTION

1. Field of the Invention

The present invention relates to a color adjusting system for use in a video wall. More particularly, the color adjusting system of the present invention is configured to determine light sources projected by light modules of display devices of the video wall and determine how to adjust the light sources according to the distribution of coordinate values of the light sources in the color space.

2. Descriptions of the Related Art

Conventional video wall technologies accomplish the display of large image primarily by using a plurality of display devices in combination. Because the plurality of display devices are used simultaneously to display a single image, coordination in terms of the brightness and colors must be made between the display devices in order for the user to watch the image on the video wall in a natural and comfortable way. In other words, if no coordination is made between the display devices of the video wall, the display devices would display portions of the image at different luminances and in different colors; and consequently, a feeling of incoordination between the portions of the image would be perceived by the audiences when watching the image on the video wall as a whole.

Conventionally, to display an image on the whole video wall uniformly, the most common practice is to adjust the video wall manually. Specifically, to display an image on the video wall uniformly, the display device(s) that needs to be adjusted is determined through manual observation and then adjusted correspondingly. However, the display devices have to be adjusted one by one when this practice of manual observation is adopted, which is very time-consuming. Moreover, because different operators have different senses of luminance and colors, differences in the displaying effect may arise between the adjusted display devices due to manual observation.

On the other hand, adjustment of the video wall may be accomplished through manual adjustment in combination with use of a standard meter to avoid errors arising from manual observation. In detail, a standard meter is used to detect the display statuses of the display devices, and then the display devices are adjusted manually according to the results measured by the standard meter. By using the standard meter to detect statuses of the display devices, the errors arising from manual observation can be reduced to facilitate subsequent manual adjustment. However, this increases the cost significantly due to the use of the standard meter; and furthermore, because manual adjustment is still needed, both the time consumed and the difficulty in adjustment will increase as the number of display devices of the video wall increases.

Accordingly, an urgent need exists in the art to provide a solution that can improve the accuracy and efficiency of adjusting an image displayed on the video wall and reduce the cost.

### SUMMARY OF THE INVENTION

To solve the problems arising in the adjustment of an image on the video wall, the present invention provides a color adjusting system for use in a video wall. The color adjusting system primarily uses color sensors to determine light signals projected by light modules of display devices of the video wall and then uses a processing module to further determine how to adjust the light modules according to the distribution of coordinate values of the light signals in the color space.

To achieve the aforesaid objective, the present invention provides a color adjusting system for use in a video wall. The video wall comprises a plurality of display devices, each having a light module. The color adjusting system comprises a plurality of color sensors and a processing module. The color sensors correspond to the display devices, and are configured to sense a plurality of red light signals, a plurality of green light signals, a plurality of blue light signals and a plurality of white light signals generated by the light modules of the display devices. The processing module is electrically connected to the color sensors, and is configured to calculate a red light color space coordinate criterion value of the red light signals, a green light color space coordinate criterion value of the green light signals, a blue light color space coordinate criterion value of the blue light signals and a white light color space coordinate criterion value of the white light signals respectively. The processing module is further configured to transmit the red light color space coordinate criterion value, the green light color space coordinate criterion value, the blue light color space coordinate criterion value and the white light color space coordinate criterion value to each of the display devices so that each of the display devices adjusts the light module thereof according to the red light color space coordinate criterion value, the green light color space coordinate criterion value, the blue light color space coordinate criterion value and the white light color space coordinate criterion value.

To achieve the aforesaid objective, the present invention also provides a color adjusting system for use in a video wall. Similarly, the video wall comprises a plurality of display devices each having a light module. The color adjusting system comprises a plurality of sensor modules and a processing module. The sensor modules correspond to the display devices, and each of the sensor modules further comprises a drive element and a color sensor. The drive element of each of the sensor modules is configured to drive the color sensor to a sensing position, and the color sensor is configured to sense a light signal generated by the light module of the corresponding display device at the sensing position. The processing module is electrically connected to the color sensors of the sensor modules, and is configured to calculate a color adjusting signal according to the light signals. The processing module is further configured to transmit the color adjusting signal to each of the display devices so that each of the display devices adjusts the light module thereof according to the color adjusting signal.

With the technical features disclosed above, the color adjusting system of the present invention can automatically adjust the light modules of the display devices of the video wall accurately and efficiently according to the light signals of the light modules so that a user can watch an image displayed on the video wall in a more proper and comfortable way.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a video wall according to a first embodiment of the present invention;

FIG. 1B is a schematic view illustrating relationships between a color adjusting system and display devices according to the first embodiment of the present invention;

FIG. 1C is a front view illustrating a color sensor corresponding to a light module according to the first embodiment of the present invention;

FIG. 1D is a color space coordinate table according to the first embodiment of the present invention;

FIG. 2A is a schematic view of a color adjusting system according to a second embodiment of the present invention;

FIG. 2B is a front view illustrating a sensor module corresponding to a light module according to the second embodiment of the present invention; and

FIG. 2C is another front view illustrating a sensor module corresponding to a light module according to the second embodiment of the present invention.

### DESCRIPTION OF THE PREFERRED EMBODIMENT

In the following descriptions, the present invention will be explained with reference to embodiments thereof. However, these embodiments are not intended to limit the present invention to any specific environment, applications or particular implementations described in these embodiments. Therefore, the description of these embodiments is only for the purpose of illustration rather than limitation. It shall be appreciated that in the following embodiments and attached drawings, elements not directly related to the present invention are omitted from depiction.

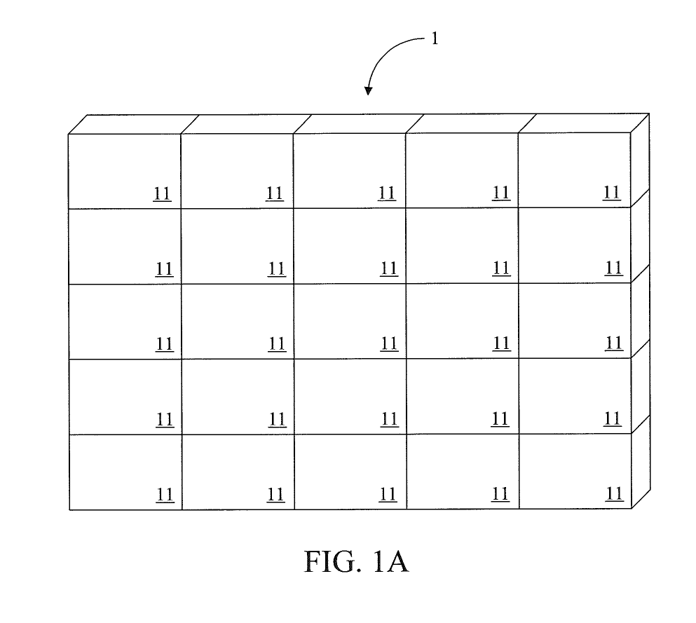

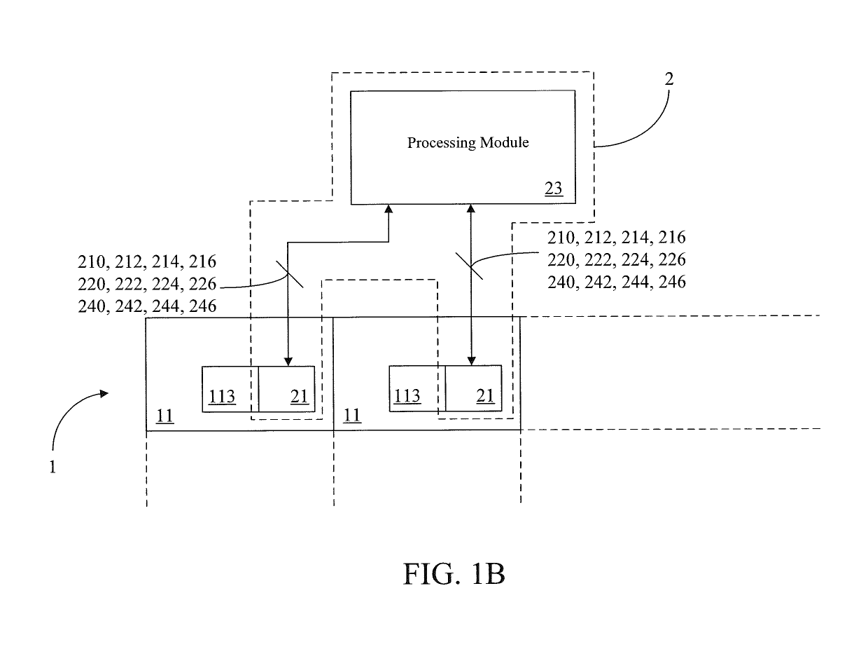

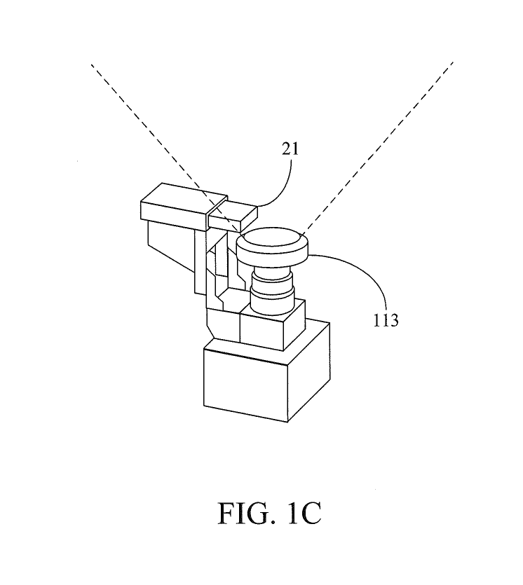

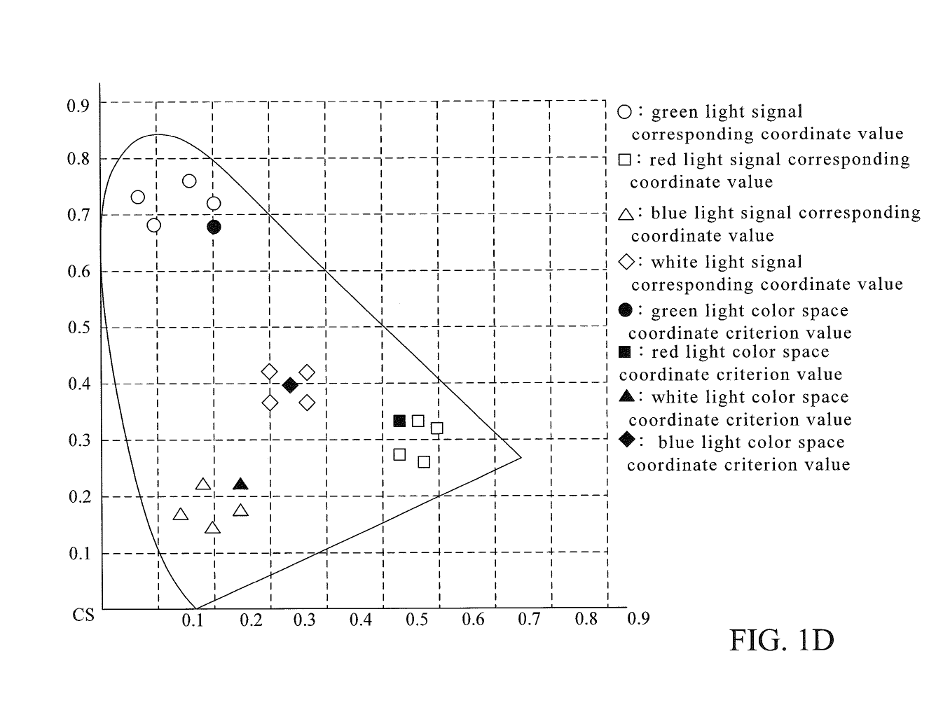

First, in reference to FIGS. 1A and 1B, FIG. 1A is a schematic view of a video wall 1 according to a first embodiment of the present invention, with the video wall 1 comprising a plurality of display devices 11. FIG. 1B is a schematic view illustrating relationships between a color adjusting system 2 and the display devices 11 according to the first embodiment of the present invention. The display devices 11 each have a light module 113. The color adjusting system 2 comprises a plurality of color sensors 21 and a processing module 23. The color sensors 21 are electrically connected to the processing module 23, and are disposed corresponding to the light modules 113 of the display devices 11 to sense the light sources of the light modules 113.

It shall be particularly emphasized that for the convenience of understanding and description, only some of the display devices 11 and some of the color sensors 21 (here, two of the display devices 11 and two of the color sensors 21) are depicted in FIG. 1B; and to the method in which to arrange more than two display devices 11 and more than two color sensors 21 will be readily known by people skilled in the art upon reviewing the attached drawings and what is disclosed in this specification and, thus, will not be further described herein. In addition, it shall be particularly appreciated that the color adjusting system 2 of the present invention may be calibrated in advance. In detail, because the color sensors 21 can only sense color energy, the color sensors 21 may be calibrated in advance to obtain the correspondence relationships between the color energy and the brightness and color coordinates so that the color sensors 21 can be used to measure color information in place of the conventional standard meters. In this way, when being used online subsequently, the color sensors 21 can obtain the brightness and color coordinate information of different colors in real time according to the correspondence relationships obtained through calibration.

Next, in reference to FIG. 1C, there is a front view illustrating a color sensor 21 corresponding to a light module 113. Specifically, the color sensor 21 is disposed on a side of the light module 113 of the corresponding display device 11. Thus, the plurality of color sensors 21 of the color adjusting system 2 can sense a plurality of red light signals 210, a plurality of green light signals 212, a plurality of blue light signals 214 and a plurality of white light signals 216 generated by the light rays projected from the light modules 113 of the corresponding display devices 11. Then, the processing module 23 that is electrically connected to the plurality of color sensors 21 calculates a red light color space coordinate criterion value 220 of the red light signals 210, a green light color space coordinate criterion value 222 of the green light signals 212, a blue light color space coordinate criterion value 224 of the blue light signals 214 and a white light color space coordinate criterion value 226 of the white light signals 216 respectively.

For convenience of understanding how to calculate the color space coordinate criterion values of different colors according to the present invention, please refer to FIG. 1D together. FIG. 1D shows a color space coordinate table CS. In detail, the red light signals 210, the green light signals 212, the blue light signals 214 and the white light signals 216 generated by the light modules 113 each have a corresponding color space coordinate value in the color space; the processing module 23 can calculate the color space coordinate criterion values accordingly. It shall be particularly appreciated that for the ease of understanding, only four coordinate values are illustrated for each of the different colors in FIG. 1D; however, people skilled in the art can readily know that the number of the coordinate values of each of the colors corresponds to the number of the light modules 113 upon reviewing the disclosure of the present invention.

Furthermore, the calculation of the red light color space coordinate criterion value 220 will be taken as an example. After receiving the red light signals 210 sensed by the color sensors 21, the processing module 23 can determine the coordinate values of the red light signals 210 in the color space coordinate table CS according to the correspondence relationships previously obtained through calibration. Because the decay of the red light represents a reduced x-axis value and increased y-axis in the color space coordinate table and because the light cannot be restored once it decays, the processing module 23 must find a red light color space x-axis minimum value (not shown) and a red light color space y-axis maximum value (not shown) according to the coordinate values of the red light signals 210 in the color space coordinate table CS and then set the red light color space x-axis minimum value and the red light color space y-axis maximum value as the red light color space coordinate criterion value 220. In this way, the red light signals 210 can be adjusted with the red light color space coordinate criterion value 220 as a reference.

Similarly, the calculation of the green light color space coordinate criterion value 222 will be taken as an example. After receiving the green light signals 212 sensed by the color sensors 21, the processing module 23 can determine the coordinate values of the green light signals 212 in the color space coordinate table CS according to the correspondence relationships previously obtained through calibration. Because the decay of the green light represents an increased x-axis value and a reduced y-axis value in the color space coordinate table and because the light cannot be restored once it decays, the processing module 23 must find a green light color space x-axis maximum value (not shown) and a green light color space y-axis minimum value (not shown) according to the coordinate values of the green light signals 212 in the color space coordinate table CS and then set the green light color space x-axis maximum value and the green light color space y-axis minimum value as the green light color space coordinate criterion value 222. In this way, the green light signals 212 can be adjusted with the green light color space coordinate criterion value 222 as a reference.

Furthermore, the calculation of the blue light color space coordinate criterion value 224 is taken as an example. After receiving the blue light signals 214 sensed by the color sensors 21, the processing module 23 can determine the coordinate values of the blue light signals 214 in the color space coordinate table CS according to the correspondence relationships previously obtained through calibration. Because the decay of the blue light represents an increased x-axis value and an increased y-axis value in the color space coordinate table and because the light cannot be restored once it decays, the processing module 23 must find a blue light color space x-axis maximum value (not shown) and a blue light color space y-axis maximum value (not shown) according to the coordinate values of the blue light signals 214 in the color space coordinate table CS and then set the blue light color space x-axis maximum value and the blue light color space y-axis maximum value as the blue light color space coordinate criterion value 224. In this way, the blue light signals 214 can be adjusted with the blue light color space coordinate criterion value 224 as a reference.

Finally, the method in which the white light color space coordinate criterion value 226 is calculated will be described. After receiving the white light signals 216 sensed by the color sensors 21, the processing module 23 can determine the coordinate values of the white light signals 216 in the color space coordinate table CS according to the correspondence relationships previously obtained through calibration. Because the decay of the white light indicates that the x-axis value and the y-axis value tend to gather in the center in the color space, the processing module 23 must find a white light color space x-axis average value (not shown) and a white light color space y-axis average value (not shown) according to the coordinate values of the white light signals 216 in the color space coordinate table CS and then set the white light color space x-axis average value and the white light color space y-axis average value as the white light color space coordinate criterion value 226. In this way, the white light signals 216 can be adjusted with the white light color space coordinate criterion value 226 as a reference.

After obtaining the red light color space coordinate criterion value 220, the green light color space coordinate criterion value 222, the blue light color space coordinate criterion value 224 and the white light color space coordinate criterion value 226 through the aforesaid calculations, the processing module 23 transmits them to each of the display devices 11 so that each of the display devices 11 adjusts the light module 113 thereof accordingly. Specifically, each of the display devices 11 can adjust the red light signals of the light module 113 thereof to meet the red light color space coordinate criterion value 220, adjust the green light signals to meet the green light color space coordinate criterion value 222, adjust the blue light signals to meet the blue light color space coordinate criterion value 224 and adjust the white light signals to meet the white light color space coordinate criterion value 226. In this way, the light rays projected by the light modules 113 of all the display devices 11 will have the same hue.

It shall be particularly appreciated that the color space of FIG. 1D is only used to explain the concept of the calculations of the present invention; however, after receiving the coordinate values corresponding to the light rays of different colors, the processing module 23 of the color adjusting system 2 of the present invention can also calculate the maximum/minimum/average color space coordinate values of the light rays according to the received coordinate values directly without using the color space.

On the other hand, the processing module 23 can further determine a red light brightness minimum value 240 of the red light signals 210, a green light brightness minimum value 242 of the green light signals 212, a blue light brightness minimum value 244 of the blue light signals 214 and a white light brightness minimum value 246 of the white light signals 216 respectively so that each of the display devices 11 can adjust the light module 113 thereof accordingly. Specifically, the color sensors 21 may also sense a red light brightness value, a green light brightness value, a blue light brightness value and a white light brightness value together when sensing the light rays of the light modules 113; and because the brightness value of a light ray cannot be restored either once the light ray decays, the brightness minimum value will be used as a basis for adjustment.

Accordingly, the processing module 23 determines the red light brightness minimum value 240 of the red light signals 210, the green light brightness minimum value 242 of the green light signals 212, the blue light brightness minimum value 244 of the blue light signals 214 and the white light brightness minimum value 246 of the white light signals 216 respectively and then transmits them back to each of the display devices 11. In this way, each of the display devices 11 can adjust the red light brightness of the light module 113 thereof accordingly to meet the red light brightness minimum value 240, adjust the green light brightness to meet the green light brightness minimum value 242, adjust the blue light brightness to meet the blue light brightness minimum value 244 and adjust the white light brightness to meet the white light brightness minimum value 246. In this way, the light rays projected by the light modules 113 of all the display devices 11 will have the same brightness.

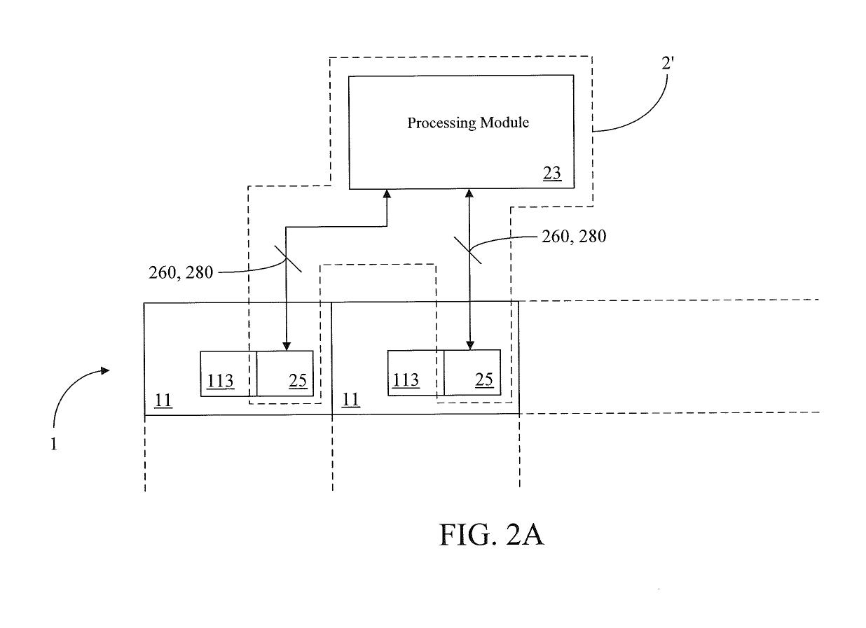

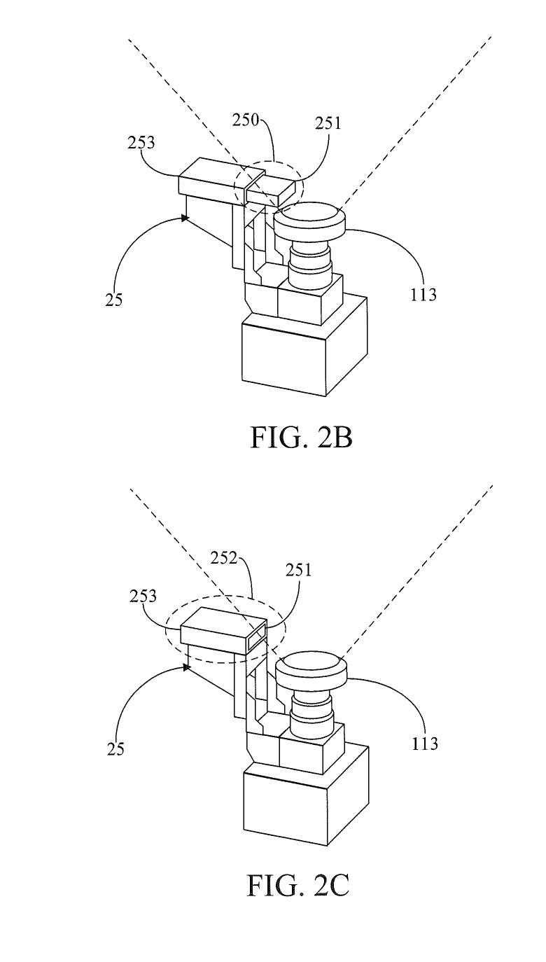

Next, FIG. 2A illustrates a schematic view of a color adjusting system 2′ according to a second embodiment of the present invention. It shall be particularly emphasized that the color adjusting system 2′ is substantially the same as the color adjusting system 2 of the first embodiment except that the sensing elements of the color adjusting system 2′ are a plurality of sensor modules 25 which also correspond to the display devices 11. FIG. 2B is a front view illustrating the sensor module 25 corresponding to a light module 113. The sensor module 25 comprises a drive element 253 and a color sensor 251. The drive element 253 is configured to drive the color sensor 251 to a sensing position 250 so that the color sensor 251 can sense light signals 260 generated from the light rays projected by the light module 113 of the corresponding display device 11 at the sensing position 250.

Similar to the first embodiment, the processing module 23 is electrically connected to the color sensors 251 of the sensor modules 25, and is configured to calculate a color adjusting signal 280 according to the light signals 260 and to transmit the color adjusting signal 280 to each of the display devices 11 so that each of the display devices 11 adjusts the light module 113 thereof according to the color adjusting signal 280. The processes of calculation and adjustment are the same as those of the first embodiment and, thus, will not be further described herein.

Next, FIG. 2C illustrates another front view of a color sensor 21 corresponding to a light module 113. It shall be particularly emphasized that in the second embodiment, each of the drive elements 253 of the sensor modules 25 can drive the corresponding color sensor 251 to an initial position 252 to enter into an idle state after the corresponding color sensor 251 has sensed the light signals 260 generated by the light module 113 of the corresponding display device 11 at the sensing position 250. Thereafter, when color adjustment needs to be made again, each of the drive elements 253 of the sensor modules 25 drives the corresponding color sensor 251 from the initial position 252 to the sensing position 250 so that the color sensor 251 senses the light signals 260 generated by the light module 113 of the corresponding display device 11.

In brief, each of the drive elements 253 functions to drive the corresponding color sensor 251 to the sensing position 250 when the sensing operation is started periodically so that the color sensor 251 is illuminated by the light projected from the light module 113 of the corresponding display device 11 to sense the light signals 260. On the other hand, each of the drive elements 253 also functions to drive the corresponding color sensor 251 to the initial position 252 when the sensing operation is ended so that the color sensor 251 enters into the idle state.

According to the above descriptions, the color adjusting system of the present invention can automatically adjust the light modules of the display devices of the video wall accurately by using low-cost color sensors and an efficient way of color adjustment so that the user can watch an image displayed on the video wall in a proper and comfortable way.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A color adjusting system for use in a video wall, the video wall comprising a plurality of display devices each having a light module, the color adjusting system comprising:
a plurality of color sensors, which correspond to the display devices, being configured to sense a plurality of red light signals, a plurality of green light signals, a plurality of blue light signals and a plurality of white light signals generated by the light modules of the display devices; and
a processing module, which is electrically connected to the color sensors;
wherein the processing module is configured to calculate a red light color space coordinate criterion value of the red light signals, a green light color space coordinate criterion value of the green light signals, a blue light color space coordinate criterion value of the blue light signals and a white light color space coordinate criterion value of the white light signals respectively, and the processing module is further configured to transmit the red light color space coordinate criterion value, the green light color space coordinate criterion value, the blue light color space coordinate criterion value and the white light color space coordinate criterion value to each of the display devices so that each of the display devices adjusts the light module thereof according to the red light color space coordinate criterion value, the green light color space coordinate criterion value, the blue light color space coordinate criterion value and the white light color space coordinate criterion value.

2. The color adjusting system as claimed in claim 1, wherein the red light color space coordinate criterion value comprises a red light color space x-axis minimum value and a red light color space y-axis maximum value.

3. The color adjusting system as claimed in claim 1, wherein the green light color space coordinate criterion value comprises a green light color space x-axis maximum value and a green light color space y-axis minimum value.

4. The color adjusting system as claimed in claim 1, wherein the blue light color space coordinate criterion value comprises a blue light color space x-axis maximum value and a blue light color space y-axis maximum value.

5. The color adjusting system as claimed in claim 1, wherein the white light color space coordinate criterion value comprises a white light color space x-axis average value and a white light color space y-axis average value.

6. The color adjusting system as claimed in claim 1, wherein the processing module is further configured to determine a red light brightness minimum value of the red light signals, a green light brightness minimum value of the green light signals, a blue light brightness minimum value of the blue light signals and a white light brightness minimum value of the white light signals respectively, and the processing module is further configured to transmit the red light brightness minimum value, the green light brightness minimum value, the blue light brightness minimum value and the white light brightness minimum value to each of the display devices so that each of the display devices adjusts the light module thereof according to the red light brightness minimum value, the green light brightness minimum value, the blue light brightness minimum value and the white light brightness minimum value.

7. A color adjusting system for use in a video wall, the video wall comprising a plurality of display devices each having a light module, the color adjusting system comprising:
a plurality of sensor modules corresponding to the display devices, each of the sensor modules comprising:
a drive element; and
a color sensor;
wherein the drive element is configured to drive the color sensor to a sensing position, and the color sensor is configured to sense a light signal generated by the light module of the corresponding display device at the sensing position; and
a processing module, which is electrically connected to the color sensors of the sensor modules;
wherein the processing module is configured to calculate a color adjusting signal according to the light signals, and to transmit the color adjusting signal to each of the display devices so that each of the display devices adjusts the light module thereof according to the color adjusting signal.

8. The color adjusting system as claimed in claim 7, wherein each of the drive elements of the sensor modules is further configured to drive the corresponding color sensor to an initial position after the corresponding color sensor senses the light signal generated by the light module of the corresponding display device at the sensing position.
